(19) United States
(12) Patent Application Publication
(10) Pub. No.: US 2019/0211285 A1
(43) Pub. Date: Jul. 11, 2019

(54) EXTERIOR CLEANING COMPOSITION FOR A VEHICLE

(71) Applicants: Douglas Alexie, Tewksbury, MA (US); Alex Lokeno, Lakewood, CA (US)

(72) Inventors: Douglas Alexie, Tewksbury, MA (US); Alex Lokeno, Lakewood, CA (US)

(21) Appl. No.: 16/241,663

(22) Filed: Jan. 7, 2019

Related U.S. Application Data
(60) Provisional application No. 62/614,605, filed on Jan. 8, 2018.

(51) Int. Cl. C11D 7/26; C11D 7/32; C11D 7/08

(52) U.S. Cl. CPC C11D 7/264; C11D 7/3263; C11D 7/265; C11D 7/08; C11D 11/0023; C11D 7/266; C11D 7/3254; C11D 7/261; C11D 7/3281; C11D 7/267

(57) ABSTRACT

Disclosed is an exterior chemical cleaning composition for a vehicle. The chemical cleaning composition may be capable of functioning as a universal cleaning solvent includes 2% hydrogen peroxide by volume, predetermined quantities of acetone water, propylene carbonate, dimethyl glutamate, dimethyl adipate, glycerin, panthenol, tocopheryl acetate, desired amount of distilled water, 1% by volume of acetate fragrance, 5 benzophenone-1, benzoate, yellow 11 and remaining water content. The chemical cleaning composition may be utilized for forming an effective solvent for cleaning a variety of surfaces including car body, kitchen hood, and other surfaces subjected to deposition of all kinds of stain, dirt, oil, marks, droppings and other coatings. The chemical cleaning composition may be used as an effective, simple and quick means for cleaning a vehicle body without affecting the underlying paint coating on the vehicle body.

### RELATED APPLICATION(S)

Under provisions of 35 U.S.C. § 119, the Applicant(s) claim the benefit of U.S. provisional application No. 62/614,605 filed Jan. 8, 2018, which is incorporated herein by reference.

### FIELD OF THE INVENTION

The present invention relates generally to cleaning compositions, and in particular to an exterior cleaning composition for a vehicle.

### BACKGROUND OF THE INVENTION

Millions of vehicle owners are familiar with the difficulties of protecting their vehicles from bird droppings, particularly when there is no garage, carport, or other roofed structure available to protect the vehicle. The acid content of the droppings can damage the finish of the vehicle. Other material, such as road tar, is also harmful to the finish and difficult to remove. Other common sources of stains include oil, grease, paint, rust, mold, plants, food and beverages, tire marks, and the like.

In most cases, a stain is a result of a chemical reaction or strong interaction, such as, adsorption or chemisorption, between a staining agent and the surface of a solid material. Known procedures for removing stains from rugged solid surfaces, such as, vehicle surfaces, stove surfaces, kitchen surfaces, floors, etc. include mechanical and chemical methods or a combination of both methods. Mechanical methods include grinding, steam cleaning, brushing, scouring and use of blow torches. In most cases, these procedures are cumbersome, labor intensive and rather expensive, and do not always give a desirable cleaning effect. Depending on the age and severity of the stain these methods may require multiple treatments to get results, which could potentially compromise the paint applied on the surface such as on a car or at times the integrity of the surface subjected to cleaning.

Existing chemical methods of stain removal from solid surfaces involve the use of special chemicals, solvents, detergents, enzymes and other biological agents. Solvents and detergents dissolve stains, whereas chemical and biological agents react with them leading to their degradation or formation of a compound that will not show as a stain.

A search of the prior art reveals various compositions which have been developed to address this set of problems, or related problems. None are closely related to the present invention, but several include features which resemble those of the present invention. Each has proven to be less than satisfactory for the present purpose in its own way. There are several prior arts proposing different chemical compositions and methods for the removal of one or more types of stain, dirt, marks, droppings or other coatings from solid surfaces. The following prior arts are hereby incorporated by reference for their supportive teachings of the present invention.

The U.S. Pat. No. 7,211,551 (priority Oct. 21, 2002), titled “Universal cleaner that cleans tough oil, grease and rubber grime” discloses a cleaning composition that easily cleans oil, grease, tar, and rubber from soiled surfaces, but does not damage metals, vehicle paints, concrete, plastics such as polycarbonate, 30 MYLAR polyester and silicone sealants, wood, ceramic, and the like. The cleaning composition includes an oil-solubilizing amount of a degreaser, a rubber-solubilizing amount of a rubber solvent, and a polar, organic diluent. In preferred embodiments, the degreaser comprises glycol ether, the rubber solvent comprises nonaromatic naphtha, and the diluent comprises an alcohol.

The U.S. Pat. No. 7,552,737 (priority Mar. 1, 2008), titled “Waterless carwash liquid composition and method for producing the same” discloses a substantially nonabrasive, liquid car cleaner composition which cleans car surfaces without an external source of water to wash or rinse. The liquid cleaner is a composition of up to toxaphene 15%, sodium lauryl sulfate 10%, paraffin 10%, isopropyl alcohol 15%, and water 50%.

The U.S. Pat. No. 6,270,754 (priority Apr. 4, 1997), titled “Antimicrobial cleaning composition” discloses an antibacterial cleaning composition which includes: (a) a quaternary ammonium compound; (b) an anionic polymer having an acid number greater than 10 wherein the anionic polymer is partially or completely neutralized by the quaternary ammonium compound to form a polymer complex and wherein the polymer complex is greater than about 15% by weight of the solids in the composition; (c) a dispersing agent and/or solvent; and (d) water. The composition can be incorporated into the matrix of sponges. Alternatively, the quaternary ammonium compound can be complexed directly to cellulosic sponges that have been functionalized with anionic groups.

The U.S. Pat. No. 6,777,380 (priority Jul. 10, 2000), titled “Compositions for cleaning organic and plasma etched residues for semiconductor devices” discloses a composition for the stripping of photoresist and the cleaning of residues from substrates, and for silicon oxide etch, comprising from about 0.01 percent by weight to about 10 percent by weight of one or more fluoride compounds, from about 10 percent by weight to about 95% by weight of a sulfoxide or sulfone solvent, and from about 20 percent by weight to about 50 percent by weight water. The composition may contain corrosion inhibitors, chelating agents, co-solvents, basic amine compounds, surfactants, acids and bases.

The U.S. Pat. No. 6,150,318 (priority Jun. 23, 1995), titled “Aerosol cleaning compositions” discloses a cleaning composition being an oil-in-water emulsion in aerosol form, characterized in that sufficient of the propellant is retained in the emulsion on discharge to a surface, such that the retained propellant boils to create a sustained bubbling action in the absence of foaming on the surface. The cleaning composition comprises an oil-in-water emulsion containing (a) 2 to 60% w/w in total amount of one or more hydrocarbon propellants such that the propellants substantially form a part of the oil phase when the composition is formulated; (b) 2 to 50% w/w in total amount of one or more surfactants; (c) 0.1 to 30% w/w in total amount of one or more water-immiscible organic compounds; (d) 0.5 to 40% w/w in total amount of one or more water-miscible organic coupling agents; and (e) 10 to 70% w/w of water.

The U.S. Patent Appl. No. 2009/0130849A1 (priority Oct. 29, 2007), titled “Chemical mechanical polishing and wafer cleaning composition comprising amidoxime compounds and associated method for use” discloses a composition and associated method for chemical mechanical planarization (or other polishing). The composition contains an amidoxime compound and water. The composition may also contain an abrasive and a compound with oxidation and reduction potential. The composition is useful for attaining improved removal rates for metal, including copper, barrier material, and dielectric layer materials in metal CMP. The composition is particularly useful in conjunction with the associated method for metal CMP applications.

The U.S. Patent Appl. No. 2002/0107161A1 (priority Dec. 7, 2000), titled “Engine cleaner composition” discloses an engine cleaner composition comprising a single phase solution comprising a polar solvent; a non-polar solvent, immiscible with the polar solvent; and a fugitive cosolvent having a higher evaporation rate than the polar solvent and the non-polar solvent. The engine cleaner compositions are suitable for cleaning internal combustion engines.

The U.S. Patent Appl. No. 2013/0072419A1 (priority Sep. 21, 2011), titled “Cleaning composition with surface modification polymer” discloses a cleaning composition which includes water, glycerine, at least one alkyl polyglycoside and a surface modification polymer. The surface modification polymer acts to provides for initial cleaning or pretreatment of the hard surface and provides a hydrophilic coating or barrier layer on the surface which provides residual cleaning to the hard surface for an extended number of cleanings. The composition has an alkaline pH of from about 8 to 10.

The U.S. Pat. No. 5,849,681 (priority Feb. 9, 1996), titled “Glass cleaner with enhanced anti-streaking properties” discloses an aqueous cleaning composition comprising a combination of at least one nonvolatile organic ether compound and at least one anti-streaking alcohol compound. If desired, these compositions may also contain one or more of the following: an amphoteric surfactant, a quaternary compound, an organic solvent, coloring and fragrance. The composition may also contain other conventional materials including, but certainly not limited to; ammonia, vinegar, chelating agents, pH modifiers, hydrotropes, and anti-microbial compounds.

The U.S. Pat. No. 6,342,474 (priority Jun. 30, 1999), titled “Hard surface cleaner containing nonionic surfactants” discloses an aqueous hard surface cleaning composition comprising a water soluble organic solvent; a nonionic surfactant selected from the group consisting of an alcohol alkoxylate, an alcohol block alkoxylate, a polyxyethylene polyoxypropylene block surfactant, and mixtures thereof; and an effective amount up to about 5% by weight of a cleaning auxiliary selected from the group consisting of methylglycine diacetic acid, hydroxyethyl ethylenediamine triacetic acid, diethylenetriamine pentaacetic acid, ethylenediamine tetraacetic acid, nitilotriacetic acid, salts thereof, and mixtures thereof; and optionally, a thickening agent. The compositions are useful for cleaning hard surfaces with a minimum of wiping and scrubbing.

The European Patent No. EP0105063A1 (priority Sep. 10, 1981), titled “Liquid hard-surface cleaner” discloses homogeneous liquid hard surface cleaning detergents which are comprised of surfactant, hydrotrope, 10.1-19% sequestering builder, and 6-15% of solvent having a molar volume below about 200 cm3/gm mol and Hansen's solubility parameters as follows: polarity parameter from zero to about 3.5 (cal./cm3)½ and hydrogen bonding parameter from zero to about 6 (cal./cm3)½. For solvents whose parameters are below about 2, an auxiliary solvent is often needed for solubilization in the formula. A preferred solvent is diethylene glycol mono-n-butyl ether. Cleaning performance at these concurrent high levels of builder and solvent is outstanding, especially for bathroom surfaces such as tubs and walls.

The existing prior arts may not be an effective solution for cleaning all types of stain, dirt, marks, droppings or other coatings from solid surfaces such as car body without affecting the underlying paint coating. Hence there exists a need for a universal solvent for cleaning all types of stain, dirt, marks, droppings or other coatings from solid surfaces such as a vehicle body, without affecting the underlying paint coating.

Accordingly, there is a need for an improved cleaning solution that may overcome one or more of the abovementioned problems and/or limitations.

### SUMMARY OF THE INVENTION

This summary is provided to introduce a selection of concepts in a simplified form that are further described below in the Detailed Description. This summary is not intended to identify key features or essential features of the claimed subject matter. Nor is this summary intended to be used to limit the claimed subject matter's scope.

According to some embodiments, an exterior chemical cleaning composition for a vehicle is disclosed. The chemical cleaning composition may be capable of functioning as a universal cleaning solvent includes 2% hydrogen peroxide by volume, predetermined quantities of acetone water, propylene carbonate, dimethyl glutamate, dimethyl adipate, glycerin, panthenol, tocopheryl acetate, desired amount of distilled water, 1% by volume of acetate fragrance, 5 benzophenone-1, benzoate, yellow 11 and remaining water content. Further, the chemical cleaning composition may be utilized for forming an effective solvent for cleaning a variety of surfaces including car body, kitchen hood, and other surfaces subjected to deposition of all kinds of stain, dirt, oil, marks, droppings and other coatings. The chemical cleaning composition may be used as an effective, simple and quick means for cleaning a vehicle body without affecting the underlying paint coating on the vehicle body.

The disclosed exterior cleaning composition for a vehicle is formulated from well-known chemical compounds.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is a front perspective view a container, in accordance with an embodiment.

FIG. 2 is a front view the container of FIG. 1.

### DETAILED DESCRIPTION OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in, the context of cleaning solutions for vehicles, embodiments of the present disclosure are not limited to use only in this context.

According to some embodiments, a chemical cleaning composition for removing all kinds of stain, dirt, marks, droppings and other coatings from solid surfaces is disclosed. The disclosed chemical cleaning composition may act as a solvent and may include predetermined quantities of one or more of hydrogen peroxide, acetone water, propylene carbonate, dimethyl glutamate, dimethyl adipate, glycerin, panthenol, tocopheryl acetate, distilled water, acetate fragrance, benzophenone-1, benzoate, yellow 11 and remaining water content. In a preferred embodiment, the chemical cleaning composition may include 2% hydrogen peroxide 15 in the solution. Further, the chemical cleaning composition may include a desired aroma or acetate fragrance of at least 1% by volume in the solution. Further, a manufacturer may add a desired aroma content or flavor. The remainder of the quantity of the disclosed chemical cleaning composition may include water.

The chemical compounds used for forming the disclosed chemical cleaning composition may be water-soluble and may form a solvent capable of applying to almost all types of surfaces for removing the different kinds of stain, dirt, marks, droppings and other coatings from solid surfaces.

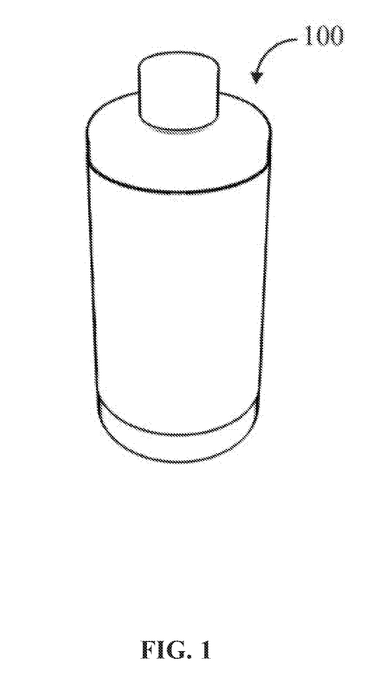

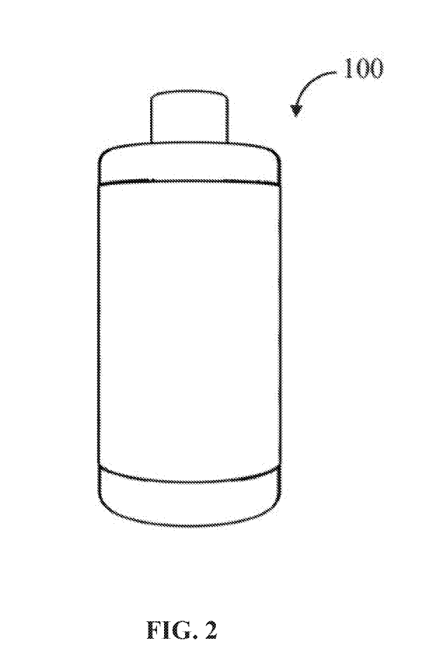

The disclosed chemical cleaning composition may evaporate or oxidize when comes in contact with air for a certain period. Accordingly, the disclosed chemical cleaning composition may be protected from sunlight and/or air and sealed in a container or bottle 100, shown in FIG. 1 and FIG. 2.

In an embodiment, the chemical cleaning composition may be utilized as a solvent or cleaning liquid for removing different kinds of stain, dirt, marks, droppings and other coatings from car body or car surfaces. The disclosed chemical cleaning composition available in liquid form in the container 100 removes all kinds of stain, dirt, marks, bird droppings and other coatings from any car body, without affecting the paint on the body of the car.

Further, the disclosed chemical cleaning composition may be utilized as a kitchen hood cleaning tool or as a microwave cleaning tool or kitchen tabletop cleaning tool as the chemical cleaning composition easily cleans the above said surface without affecting the underlying paint of finishing. In another instance, the disclosed chemical cleaning composition can be used as an additive or solvent for removing all kinds of stain, dirt, oil, marks, droppings and other coatings from car body.

The disclosed chemical cleaning composition can be made available to the user in different capacities such as small, medium, and large bottles. Further, the disclosed chemical cleaning composition and method of cleaning the solid surfaces such as car and other vehicles is simple and unique with an effortless cleaning process utilizing the present chemical cleaning composition. The disclosed chemical cleaning composition is not expensive, offer quick cleaning and can be effectively used for cleaning car surfaces without affecting its paint. The user may simply dip or soak a small portion of cloth in the disclosed chemical cleaning composition and rub it on the surface to remove all kinds of stain, dirt, oil, marks, droppings and other coatings from the surface.

The disclosed cleaning composition may be preferably manufactured from 2% hydrogen peroxide by volume, predetermined quantities of acetone water, propylene carbonate, dimethyl glutamate, dimethyl adipate, glycerin, panthenol, tocopheryl acetate, desired amount of distilled water, 1% by volume of acetate fragrance, 5 benzophenone-1, benzoate, yellow 11 and remaining water content. Components and methods listed above are preferable, but artisans will recognize that alternate components and methods could be selected without altering the scope of the invention.

Although the invention has been explained in relation to its preferred embodiment, it is to be understood that many other possible modifications and variations can be made without departing from the spirit and scope of the invention.

What is claimed is:

1. An exterior cleaning composition for a vehicle, comprised of a chemical cleaning composition for removing all kinds of stain, dirt, marks, droppings and other coatings from solid surfaces, according to a preferred embodiment of the present invention.

2. The cleaning composition of claim 1, wherein the cleaning composition acts as a solvent and includes predetermined quantities of hydrogen peroxide, acetone water, propylene carbonate, dimethyl glutamate, dimethyl adipate, glycerin, panthenol, tocopheryl acetate, distilled water, acetate fragrance, benzophenone-1, benzoate, yellow 11 and remaining water content.

3. The cleaning composition of claim 2, wherein the cleaning composition includes 2% hydrogen peroxide 15 in the solution.

4. The cleaning composition of claim 3, wherein the cleaning composition further includes a desired aroma or acetate fragrance of at least 1% by volume in the solution.

5. The cleaning composition of claim 3, wherein the chemical compounds used for forming the cleaning composition are water-soluble and form a solvent capable of applying to almost all types of surfaces for removing the different kinds of stain, dirt, marks, droppings and other coatings from solid surfaces.

6. The cleaning composition of claim 3, wherein the cleaning composition is protected from sunlight and sealed in a container or bottle, as the contents may evaporate or oxidize when coming in contact with air for a certain period.

7. The cleaning composition of claim 3, wherein the cleaning composition can be utilized as a solvent or cleaning liquid for removing different kinds of stain, dirt, marks, droppings and other coatings from car body or car surfaces.

8. The cleaning composition of claim 3, wherein the cleaning composition is further utilized as a kitchen hood cleaning tool or as a microwave cleaning tool or kitchen tabletop cleaning tool as the chemical cleaning composition easily cleans the above said surface without affecting the underlying paint of finishing.
